(19) United States
(12) Patent Application Publication
(10) Pub. No.: US 2010/0187865 A1
(43) Pub. Date: Jul. 29, 2010

(54) FRAME SIDE COMPONENT OF BODYWORK OF A MOTOR VEHICLE

(75) Inventors: Thomas MALEK, Pulheim (DE); Boris KOCH, Wermelskirchen (DE); Ulrich DAJEK, Leverkusen (DE); Ralf ZIMNOL, Overath (DE); Frank LUTTER, Dusseldorf (DE)

Correspondence Address: Hildebrand, Christa;Norris McLaughlin & Marcus PA, 875 Third Avenue, 8th Floor, New York, NY, 10022, US

(73) Assignee: LANXESS DEUTCHLAND GMBH, Leverkusen (DE)

(21) Appl. No.: 12/691,770

(22) Filed: Jan. 22, 2010

(30) Foreign Application Priority Data
Jan. 23, 2009 (DE) 10 2009 005 763.3

(51) Int. Cl. B62D 21/00; B21D 53/88

(52) U.S. Cl. 296/203.03; 29/897.2

(57) ABSTRACT

The present invention relates to a frame side component of bodywork of a motor vehicle, preferably a car, where, respectively, a metal outer frame manufactured as a single piece and a metal inner frame manufactured as a single piece, where these respectively have at least one aperture delimited by a roof arch segment, a body-floor longitudinal-member segment and a central-column segment, are securely connected to one another, and the cavities produced between metal outer frame and metal inner frame via the connection are reinforced by reinforcement structures composed of moulded-on plastic and the reinforcement structures enter into a secure metal-plastic connection with the two frames.

### FIELD OF THE INVENTION

The present invention relates to a frame side component of bodywork of a motor vehicle, of plastics-metal-hybrid design.

### BACKGROUND OF THE INVENTION

DE 195 19 779 A1 discloses the complete side frame of a motor vehicle, composed of a peripheral structure, which includes two (door) apertures and a central column, composed of separately prefabricated individual components made of aluminium, for purposes of weight reduction. A disadvantage of the embodiment described in that document is its high weight, due to the thicknesses of aluminium that are to be used.

If relatively thin steel sheets are used as an alternative, with high elasticity thresholds, this leads to problems in the deep-drawing process, and there is also a lack of mechanical strength.

EP 1 205 377 A1 describes reduction of the weight of a side frame component of a motor vehicle while avoiding the problems during the deep-drawing process and with retention of mechanical strength, by respectively forming the roof arch, the longitudinal member and the central column of a side frame component of a motor vehicle from a single-piece component composed of aluminium or of its alloys, where the central column has been secured directly to the roof arch and to the longitudinal member and the roof arch and the longitudinal member have been secured directly to adjacent elements of the bodywork.

The disadvantage of this type of structure according to EP 1 205 377 A1 is, however, that an individual production step has to be provided for each of the constituents of the frame side component, and that when the individual components are joined together the result is overlaps where the components are joined, and this in turn requires increased use of metal. Another disadvantage of constructing a frame side component from individual modules is that the points of weakness of the component are situated at its joints/welds, the result being that it is not always possible to ensure the safety of the occupants if a side impact results from a crash. Additional reinforcement elements have to be attached and these additionally increase the weight of the entire frame side component.

However, the current trend among producers of motor vehicles is towards lower vehicle weight and, associated with this, lower fuel consumption and lower carbon dioxide emission.

EP-A 0 370 342 discloses a lightweight component of hybrid design, composed of a shell-type main body, the interior of which has reinforcement ribs, securely connected to the main body in that the reinforcement ribs are composed of moulded-on plastic and their connection to the main body takes place at discrete connection sites by way of perforations in the main body, where the plastic extends through these and extends across the surfaces of the perforations, and a secure interlock bond is achieved.

EP 1 032 526 A1 discloses a load-bearing structure for the front module of a motor vehicle, composed of a steel-sheet main body, of an unreinforced amorphous thermoplastic material, of a glass-fibre-reinforced thermoplastic, and also of a rib structure composed of, for example, polyamide.

EP 1 232 935 A1 describes, under the title vehicle bodywork, the reinforcement of a U-shaped strut formed from steel sheet, in bodywork with bulkhead walls composed of plastic, where the said bulkhead walls are produced by the injection-moulding process and have been connected by means of an interlock bond either to the strut itself or to a member that can be inserted into the said strut.

A disadvantage of the designs of the prior art is the fact that these individual components must first be combined to give a bodywork frame side component, in a manner similar to that described in EP 1 205 377 A1, the result of this being metal overlaps at their fastening points. This in turn increases the weight of the entire bodywork.

### SUMMARY OF THE INVENTION

The object of the present invention therefore consisted in, rather than applying the concept of plastics-metal-hybrid design to individual motor-vehicle bodywork components, e.g. struts or front ends, manufacturing the complex structure of a bodywork frame side component entirely as a plastics-metal-hybrid component.

The object is achieved by, and the present invention therefore provides, a frame side component of bodywork of motor vehicles, preferably cars, characterized in that respectively a metal outer frame manufactured as a single piece and a metal inner frame manufactured from a minimum small number of individual metal sheets, and particularly preferably manufactured as a single part, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.

### DETAILED DESCRIPTION OF THE INVENTION

For the purposes of the present invention, a small number of individual metal sheets means from 1 to 5 metal sheets, preferably from 1 to 4 metal sheets, particularly preferably from 1 to 3 metal sheets, very particularly preferably from 1 to 2 metal sheets and with particular preference 1 metal sheet (single-part).

For clarification, it should be noted that the scope of the invention comprises any desired combination of all of the definitions and parameters listed either in general terms or with preferred ranges below.

The sandwich-type structure, according to the invention, of a bodywork frame side component firstly reduces the number of production steps, because the number of frame components that have to be subjected to the deep-drawing process is then only two, namely the metal outer frame and the metal inner frame, and secondly eliminates the connection sites identified as weak points of bodywork: those between A-column, B-column and C-column respectively with the roof arch, and these columns respectively with the longitudinal member. Surprisingly, this method can moreover give a reduction in the thickness of the metal sheet in both frame components (outer frame component and inner frame component), leading not only to elimination of the overlap regions of the individual connection sites but also to savings in metal and therefore to the desired reductions described above in fuel consumption and carbon dioxide emissions. Furthermore, the single-part nature respectively of outer frame component and inner frame component and the complete filling of the cavity formed by the outer frame component and by the inner frame component with a reinforcement structure composed of plastic provides markedly improved side-impact crash performance.

For the purposes of the present invention, metals are preferably iron, galvanized iron, aluminium, titanium or magnesium, or else their alloys, such as steel, particular preference being given to steel or aluminium.

According to the invention, the component A) used preferably comprises plastics from the group of polyesters, polyamides, polyurethanes, polycarbonates or polyalkylenes, particularly preferably semicrystalline thermoplastics. In particular, polyamides are especially preferred, since bodywork frame side components are mostly subjected to an electrocoat process, preferably to cathodic deposition coating (CDC).

In one preferred embodiment, the reinforcement structures also have secure connection to the metal outer frame and to the metal inner frame in that the reinforcement structures are composed of moulded-on plastic and their connection to the metal outer frame and/or to the metal inner frame takes place at discrete connection sites by way of perforations in the two frames, where the plastic extends through the perforations and over the surfaces of the perforations, and a secure interlock bond is achieved when the plastic solidifies.

For the purposes of the present invention a secure interlock bond means that, either by way of microstructures in the surface of the main body, i.e. of the metal outer frame or of the metal inner frame, or by means of the perforations provided in the two frames, the extruded plastic enters into a secure connection with this/these, and the said secure interlock bond is free from play, and the only way of separating the connected sub-sections, composed of metal on the one hand and of injected thermoplastic on the other hand, is to use a load to disrupt the cross section that provides the interlock bond.

However, it is also possible in one particularly preferred embodiment, in an additional operation, to carry out further mechanical work with a tool on the flashes protruding through the apertures in such a way as to provide additional strengthening of the interlock bond. The term “securely connected” also includes subsequent incorporation by adhesion using adhesives or using a laser. However, the secure interlock bond can also be achieved via flow around (forming a web around) the main body.

The reinforcement structures preferably have a rib shape and particularly preferably can together form rectangular, diamond-shaped or honeycomb structures.

According to other preferred embodiments of the invention, which can be used individually or combined with one another in any desired manner
the fastening points of the plastic which are visible on the metal outer frame, on the outer side, are covered by plastics coverings, in order to achieve a smooth outwards-facing surface,
the region of the roof arch and also the metal outer frame and also of the metal inner frame is a rounded region,
the cross section of the region intended to form the central column (B-column) changes along its length, preferably increasing from the region connected to the roof arch towards the region connected to the longitudinal member,
the metal outer frame preferably has a U-shaped cross section in the region which is intended to form the B-column and the longitudinal member,
the metal outer frame and metal inner frame are secured or connected to one another via weld points,
both the metal outer frame and the metal inner frame are obtained via hydroforming and have variable cross sections which vary as a function of the stiffness of the respective bodywork region to be achieved in certain zones,
the metal outer frame and the metal inner frame have, in the region of the body-floor longitudinal member to be formed, along their length, a thickness which varies as a function of the stiffness to be achieved in certain zones,
the connection of the plastic structure to the inner side wall takes place at plastics pegs, preferably being a constituent of the plastics structure, where these protrude through apertures in the metal sheet and subsequently are flattened by heating, preferably by the hot-riveting method,
the connection of the plastic structure to the inner side wall takes place via a foamable plastics component or via adhesive, which was either previously used during the welding of the sheet-metal shells—or is applied subsequently (after the welding of the metal sheets of the side wall).

The plastics to be used as component A) are preferably semicrystalline thermoplastics provided as moulding compositions and injected via shaping processes through apertures in the frame side components into the cavities provided between outer frame component and inner frame component. For the purposes of the present invention, shaping processes are preferably injection moulding, melt extrusion, compression moulding, stamping or blow moulding.

Moulding compositions whose use is preferred comprise from 99.99 to 10 parts by weight, preferably from 99.5 to 40 parts by weight, particularly preferably from 99.0 to 55 parts by weight, of one of the abovementioned thermoplastics or a mixture of one or more of the abovementioned thermoplastics.

Plastics whose use is particularly preferred are nylon-6 (PA 6) and also nylon-6,6 (PA 66) with relative solution viscosities (measured in m-cresol at 25° C.) of from 2.0 to 4.0, and particularly preferably nylon-6 with a relative solution viscosity (measured in m-cresol at 25° C.) of from 2.3 to 2.6, or a mixture composed of
A) from 99.99 to 10 parts by weight, preferably from 99.5 to 40 parts by weight, particularly preferably from 99.0 to 55 parts by weight, of polyamide with B) from 0.01 to 50 parts by weight, preferably from 0.25 to 20 parts by weight, particularly preferably from 1.0 to 15 parts by weight, of an additional flow improver from the group
B1) of a copolymer composed of at least one olefin, preferably one α-olefin, with at least one methacrylate or acrylate of an aliphatic alcohol, preferably of an aliphatic alcohol having from 1 to 30 carbon atoms, whose MFI (melt flow index) is not less than 100 g/10 min, where the MFI is measured or determined at 190° C. with a test weight of 2.16 kg, or
B2) of a highly branched or hyperbranched polycarbonate with an OH number of from 1 to 600 mg KOH/g of polycarbonate (to DIN 53240, Part 2), or
B3) of a highly branched or hyperbranched polyester of AₓB_{y} type, where x is at least 1.1 and y is at least 2.1 or
B4) of a polyalkylene glycol ester (PAGE) with low molecular weight of the general formula (I)

R—COO—(Z—O)ₙOC—R (I)
in which
R is a branched or straight-chain alkyl group having from 1 to 20 carbon atoms,
Z is a branched or straight-chain C₂ to C₁₅ alkylene group and
n is a whole number from 2 to 20, or
   a mixture of B1) with B2) or of B2) with B3) or of B1) with B3) or of B1) with B2) and with B3) or of B1) with B4) or of B2) with B4) or of B3) with B4), or a ternary mixture of components B1) to B4) respectively with A), where the secure interlock bond between main body and thermoplastic takes place by way of the galvanized iron surface of the main body.

However, according to the invention the term polyamide also includes polyamides which comprise linear macromolecular chains and macromolecular chains having a star-shaped structure. These polyamides, which have improved flow due to their structure, are obtained by polymerizing, according to DE 699 09 629 T2, a mixture of monomers which comprises at least

a) monomers of the general formula (II) R₁-(-A-Z)ₘ,
b) monomers of the general formulae (IIIa) X—R₂—Y and (IIIb) R₂—NH—C═O,
c) monomers of the general formula (IV) Z—R₃—Z, in which
R₁ is a linear or cyclic, aromatic or aliphatic hydrocarbon moiety which comprises at least two carbon atoms and which can comprise heteroatoms,
A is a covalent bond or an aliphatic hydrocarbon moiety having from 1 to 6 carbon atoms,
Z′ is a primary amine moiety or a carboxy group,
R₂ and R₃ are identical or different and are aliphatic, cycloaliphatic or aromatic, substituted or unsubstituted hydrocarbon moieties which comprise from 2 to 20 carbon atoms and which can comprise heteroatoms, and
Y is a primary amine moiety, if X is a carbonyl moiety, or Y is a carbonyl moiety, if X is a primary amine moiety, where m is a whole number from 3 to 8.

The molar concentration of the monomers of the formula (II) in the monomer mixture is from 0.1% to 2%, and that of the monomers of the formula (IV) is from 0.1% to 2%, and the balance of 100% here corresponds to the monomers of the general formulae (IIIa) and (IIIb).

In one preferred embodiment, these polyamides which comprise linear macromolecular chains and macromolecular chains having a star-shaped structure are used irrespectively of the use of a component B), since, in comparison with a standard polyamide, the said polyamides are improved-flow polyamides simply because of their structure.

The moulding-on of the thermoplastic preferably takes place in one operation. In the event that the main body additionally still has perforations that require overmoulding, the procedure for the moulding-on and overmoulding of the thermoplastic can be carried out in one, two, three or more steps, as also can the forming process carried out on the flash on the opposite side, to give a plug.

In one preferred embodiment, the outer frame component or the inner frame component can, at least locally, have the shape of a shell, particularly preferably being U-shaped, in order to accept the reinforcement structures.

As previously mentioned, it is preferable according to the invention that the thermoplastic or component A) used in the moulding compositions to be processed comprises polyamide. Particularly preferred polyamides according to the invention are described by way of example in Kunststoff-Taschenbuch [Plastics Handbook] (Ed. Saechtling), 1989 edition, where sources are also mentioned. The person skilled in the art is aware of processes for the production of these polyamides. The effects to be achieved are apparent with all of the variations known in the prior art cited above for the use of hybrid technology, irrespective of whether the thermoplastic is securely connected only in part or across its entire surface to the main body or, as in the case of EP 1 380 493 A2, merely forms a web surrounding the same, and irrespective of whether the thermoplastic is additionally held in place by adhesive bond or is connected to the main body by, for example, a laser, or, as in WO 2004/071741, an additional operation is used to obtain the secure interlock bond of plastics part and metal part.

Polyamides to be used with very particular preference as component A) are nylon-6 (PA 6) or nylon-6,6 (PA 66) or a blend comprising mainly polyamide.

Polyamides to be used with particular preference according to the invention as component A) are semicrystalline polyamides which can be produced starting from diamines and dicarboxylic acids and/or from lactams having at least 5 ring members or from corresponding amino acids. Starting materials that can be used for this purpose are aliphatic and/or aromatic dicarboxylic acids, e.g. adipic acid, 2,2,4- and 2,4,4-trimethyladipic acid, azelaic acid, sebacic acid, isophthalic acid, terephthalic acid, aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclo-hexane, phenylenediamines, xylylenediamines, aminocarboxylic acids, e.g. aminocaproic acid, or the corresponding lactams. Copolyamides composed of a plurality of the monomers mentioned are included.

Polyamides preferred according to the invention are those produced from caprolactams, very particularly preferably from ε-caprolactam, and most of the compounded materials based on PA 6, on PA 66, and on other aliphatic and/or aromatic polyamides or copolyamides, where these have from 3 to 11 methylene groups for each polyamide group in the polymer chain.

Semicrystalline polyamides to be used according to the invention as component A) can also be used in a mixture with other polyamides and/or with further polymers. It is also possible, therefore, to use polyamides which accord with DE 699 09 629 T2 in that the percentage by number of macromolecular chains of star type present is from 50% to 90%.

Conventional additives can be admixed in the melt of the polyamides, or applied to the surface, examples being mould-release agents, stabilizers and/or flow aids.

In one alternative embodiment, however, it is also possible to use PA recyclates, if appropriate in a mixture with polyalkylene terephthalates, such as polybutylene terephtalates (PBT).

According to the invention, the term recyclates encompasses
1) “post-industrial recyclates”, which are production wastes arising during the polycondensation reaction or sprues arising during processing by injection moulding, start-up products from injection moulding or extrusion, or edge cuts of extruded sheets or foils, and
2) “post-consumer recyclates”, which are plastics items collected by the final consumer after use, and treated.

Both types of recyclate can be used either in the form of regrind or in the form of pellets. In the latter case, the crude recyclates are melted in an extruder, after separation and purification, and pelletized. This mostly facilitates handling and free flow, and metering for further steps of processing.

It is possible to use either pelletized recyclates or those in the form of regrind, but the maximum edge length here should be 10 mm, preferably below 8 mm.

If the intention is to use flow improvers, in addition to the plastic, the moulding compositions to be used according to the invention can comprise at least one component B), where the component B) used can comprise at least one flow improver from the group of B1), B2), B3) or B4).

According to the invention, B1) are copolymers, preferably random copolymers, composed of at least one olefin, preferably α-olefin, and of at least one methacrylate or acrylate of an aliphatic alcohol. In one preferred embodiment, these are random copolymers composed of at least one olefin, preferably α-olefin, and of at least one methacrylate or acrylate with an MFI of no less than 100 g/10 min, preferably no less than 150 g/10 min, particularly preferably no less than 300 g/10 min, where, for the purposes of the present invention, the MFI (melt flow index) was measured or determined uniformly at 190° C. with a test weight of 2.16 kg.

In one particularly preferred embodiment, the copolymer B1) is composed of less than 4% by weight, particularly preferably less than 1.5% by weight and very particularly preferably 0% by weight, of monomer units which contain further reactive functional groups selected from the group consisting of epoxides, oxetanes, anhydrides, imides, aziridines, furans, acids, amines and oxazolines.

Olefins, preferably α-olefins, suitable as constituent of the copolymers B1) preferably have from 2 to 10 carbon atoms and can be unsubstituted or can have substitution by one or more aliphatic, cycloaliphatic or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and ethene is particularly preferred.

Mixtures of the olefins described are also suitable.

In an embodiment to which further preference is given, the further reactive functional groups of the copolymer B1), selected from the group consisting of epoxides, oxetanes, anhydrides, imides, aziridines, furans, acids, amines, oxazolines, are introduced exclusively by way of the olefins into the copolymer B1).

The content of the olefin in the copolymer B1) is from 50 to 90% by weight, preferably from 55 to 75% by weight.

The copolymer B1) is further defined via the second constituent alongside the olefin. A suitable second constituent is alkyl esters or arylalkyl esters of acrylic acid or methacrylic acid whose alkyl or arylalkyl group is formed from 1 to 30 carbon atoms. The alkyl or arylalkyl group here can be linear or branched, and also can contain cycloaliphatic or aromatic groups, and alongside this can also have substitution by one or more ether or thioether functions. Other suitable methacrylates or acrylates in this connection are those synthesized from an alcohol component based on oligoethylene glycol or on oligopropylene glycol having only one hydroxy group and at most 30 carbon atoms.

By way of example, the alkyl group or arylalkyl group of the methacrylate or acrylate can have been selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. Preference is particularly also given to branched alkyl groups which have the same number of carbon atoms as linear alkyl groups but give a lower glass transition temperature T_{G}.

According to the invention, an aryl group is a molecular moiety based on an aromatic skeleton, preferably being a phenyl radical.

Particular preference according to the invention is given to copolymers B1) in which the olefin is copolymerized with 2-ethylhexyl acrylate. Mixtures of the acrylates or methacylates described are also suitable.

It is preferable here to use more than 60% by weight, particularly preferably more than 90% by weight and very particularly preferably 100% by weight, of 2-ethylhexyl acrylate, based on the total amount of acrylate and methacrylate in copolymer B1).

In an embodiment to which further preference is given, the further reactive functional groups selected from the group consisting of epoxides, oxetanes, anhydrides, imides, aziridines, furans, acids, amines, oxazolines in the copolymer B1) are introduced exclusively by way of the acrylate or methacrylate into the copolymer B1).

The content of the acrylate or methacrylate in the copolymer B1) is from 10 to 50% by weight, preferably from 25 to 45% by weight.

A feature of suitable copolymers B1) is not only their constitution but also their low molecular weight, their MFI value (melt flow index) measured at 190° C. with a load of 2.16 kg being at least 100 g/10 min, preferably at least 150 g/10 min, particularly preferably at least 300 g/10 min.

The moulding compositions according to the invention can comprise, as component B), as an alternative to B1) or in addition to B1), from 0.01 to 50% by weight, preferably from 0.5 to 20% by weight and in particular from 0.7 to 10% by weight, of B2) at least one highly branched or hyperbranched polycarbonate with an OH number of from 1 to 600 mg KOH/g of polycarbonate, preferably from 10 to 550 mg KOH/g of polycarbonate and in particular from 50 to 550 mg KOH/g of polycarbonate (to DIN 53240, Part 2) or of at least one hyperbranched polyester as component B3) or a mixture of B1) with B2) or of B2) with B3) or of B1) with B3) or a mixture of B1) with B2) and with B3).

For the purposes of this invention, hyperbranched polycarbonates B2) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component B2) preferably has a number-average molar mass Mₙ of from 100 to 15 000 g/mol, preferably from 200 to 12 000 g/mol, and in particular from 500 to 10 000 g/mol (GPC, PMMA standard).

The glass transition temperature Tg is in particular from −80 to +140° C., preferably from −60 to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component B2) is preferably obtainable via a process which comprises at least the following steps:
a) reaction of at least one organic carbonate (CA) of the general formula RO[(CO)]nOR with at least one aliphatic, aliphatic/aromatic or aromatic alcohol (AL) which has at least 3 OH groups, with elimination of alcohols ROH to give one or more condensates (K), where each R, independently of the others, is a straight-chain or branched aliphatic, aromatic/aliphatic or aromatic hydrocarbon radical having from 1 to 20 carbon atoms, and where the radicals R may also have bonding to one another to form a ring, and n is a whole number from 1 to 5, or
ab) reaction of phosgene, diphosgene, or triphosgene with an alcohol (AL) mentioned under a), with elimination of hydrogen chloride, or
b) intermolecular reaction of the condensates (K) to give a highly functional, highly branched, or highly functional, hyperbranched polycarbonate, where the quantitative proportion of the OH groups to the carbonates in the reaction mixture is selected in such a way that the condensates (K) have an average of either one carbonate group and more than one OH group or one OH group and more than one carbonate group.

Phosgene, diphosgene, or triphosgene may be used as starting material, but preference is given to organic carbonates.

Each of the radicals R of the organic carbonates (CA) used as starting material and having the general formula RO(CO)OR is, independently of the others, a straight-chain or branched aliphatic, aromatic/aliphatic or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms, or a substituted or unsubstituted phenyl radical.

In particular, use is made of simple carbonates of the formula RO(CO)OR; n is preferably from 1 to 3, in particular 1.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic, aromatic/aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates where n is greater than 1 comprise dialkyl dicarbonates, such as di(tert-butyl) dicarbonate, or dialkyl tricarbonates, such as di(tert-butyl) tricarbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (AL) which has at least 3 OH groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl)isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4-hydroxyphenyl)ethane, or sugars, e.g. glucose, trihydric or higher polyhydric polyetherols based on trihydric or higher polyhydric alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols (AL′), with the proviso that the average OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxy-phenyl)sulphide, bis(4-hydroxyphenyl)sulphone, bis(hydroxymethyl)benzene, bis-(hydroxymethyl)toluene, bis(p-hydroxyphenyl)methane, bis(p-hydroxyphenyl)ethane, 2,2-bis(hydroxyphenyl)propane, 1,1-bis(p-hydroxyphenyl)cyclohexane, dihydroxybenzophenone, dihydric polyether polyols based on ethylene oxide, propylene oxide, butylene oxide, or mixtures of these, polytetrahydrofuran, polycaprolactone, or polyesterols based on diols and dicarboxylic acids.

The diols serve for fine adjustment of the properties of the polycarbonate. If use is made of dihydric alcohols, the ratio of dihydric alcohols (AL′), to the at least trihydric alcohols (AL) is set by the person skilled in the art and depends on the desired properties of the polycarbonate. The amount of the alcohol(s) (AL′) is generally from 0 to 39.9 mol %, based on the total amount of all of the alcohols (AL) and (AL′) taken together. The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the highly functional highly branched polycarbonate takes place with elimination of the monofunctional alcohol or phenol from the carbonate molecule.

The highly functional highly branched polycarbonates have termination by hydroxy groups and/or by carbonate groups after their preparation, i.e. with no further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a highly functional polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The highly functional polycarbonates of the present invention mostly have no more than 500 terminal or pendant functional groups, preferably no more than 100 terminal or pendant functional groups.

When preparing the highly functional polycarbonates B2), it is necessary to adjust the ratio of the compounds comprising OH groups to phosgene or carbonate in such a way that the simplest resultant condensate (hereinafter termed condensate (K)) comprises an average of either one carbonate group or carbamoyl group and more than one OH group or one OH group and more than one carbonate group or carbamoyl group. The simplest structure of the condensate (K) composed of a carbonate (CA) and a di- or polyalcohol (B) here results in the arrangement XYn or YnX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (K) from a carbonate and a dihydric alcohol the reaction ratio is 1:1, the average result is a molecule of XY type, illustrated by the general formula (V).

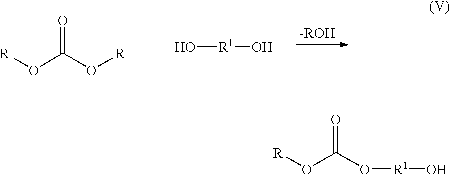

During the preparation of the condensate (K) from a carbonate and a trihydric alcohol with a reaction ratio of 1:1, the average result is a molecule of XY₂ type, illustrated by the general formula (VI). A carbonate group is focal group here.

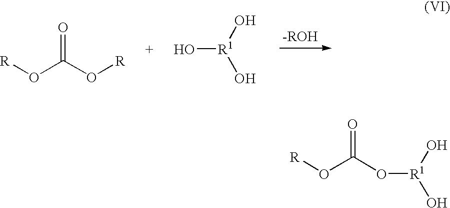

During the preparation of the condensate (K) from a carbonate and a tetrahydric alcohol, likewise with the reaction ratio 1:1, the average result is a molecule of XY₃ type, illustrated by the general formula (VII). A carbonate group is focal group here.

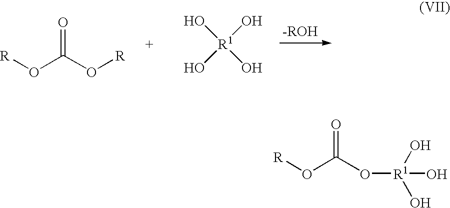

R in the formulae (V) to (VII) has the definition given above, and R¹ is an aliphatic or aromatic radical.

The condensate (K) may, by way of example, also be prepared from a carbonate and a trihydric alcohol, as illustrated by the general formula (VIII), the molar reaction ratio being 2:1. Here, the average result is a molecule of X₂Y type, an OH group being focal group here. In formula (VIII), R and R¹ are as defined in formulae (V) to (VII).

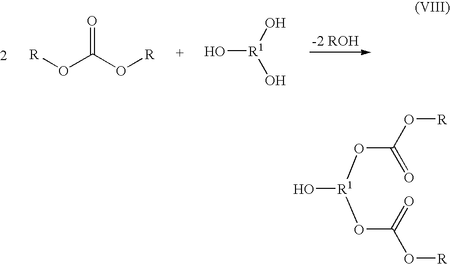

If difunctional compounds, e.g. a dicarbonate or a diol, are also added to the components, this extends the chains, as illustrated by way of example in the general formula (IX). The average result is again a molecule of XY₂ type, a carbonate group being focal group.

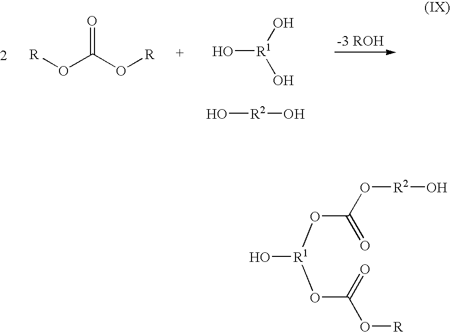

In formula (IX), R² is an organic, preferably aliphatic radical, and R and R¹ are as defined above.

It is also possible to use two or more condensates (K) for the synthesis. Here, firstly two or more alcohols or two or more carbonates may be used. Furthermore, mixtures of various condensates of different structure can be obtained via the selection of the ratio of the alcohols used and of the carbonates or the phosgenes. This may be illustrated taking the example of the reaction of a carbonate with a trihydric alcohol. If the starting products are reacted in a ratio of 1:1, as shown in (VI), the result is an XY₂ molecule. If the starting products are reacted in a ratio of 2:1, as shown in (VIII), the result is an X₂Y molecule. If the ratio is from 1:1 to 2:1, the result is a mixture of XY₂ and X₂Y molecules.

According to the invention, the simple condensates (K) described by way of example in the formulae (V) to (VII) preferentially react intermolecularly to form highly functional polycondensates, hereinafter termed polycondensates (P). The reaction to give the condensate (K) and to give the polycondensate (P) usually takes place at a temperature of from 0 to 250° C., preferably from 60 to 160° C., in bulk or in solution.

Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one embodiment, the condensation reaction is carried out in bulk. To accelerate the reaction, the phenol or the monohydric alcohol ROH liberated during the reaction can be removed by distillation from the reaction equilibrium if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, of potassium, or of cesium, tertiary amines, guanidines, ammonium compounds, phosphonium compounds, organoaluminium, organotin, organozinc, organotitanium, organozirconium, or organobismuth compounds, or else what are known as double metal cyanide (DMC) catalysts, e.g. as described in DE-A 10138216 or DE-A 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (P) may moreover be adjusted by way of the composition of the starting components and by way of the residence time.

The condensates (K) and the polycondensates (P) prepared at an elevated temperature are usually stable at room temperature for a relatively long period.

The nature of the condensates (K) permits polycondensates (P) with different structures to result from the condensation reaction, these having branching but no crosslinking. Furthermore, in the ideal case, the polycondensates (P) have either one carbonate group as focal group and more than two OH groups or else one OH group as focal group and more than two carbonate groups. The number of the reactive groups here is the result of the nature of the condensates (K) used and the degree of polycondensation.

By way of example, a condensate (K) according to the general formula (VI) can react via triple intermolecular condensation to give two different polycondensates (P), represented in the general formulae (X) and (XI).

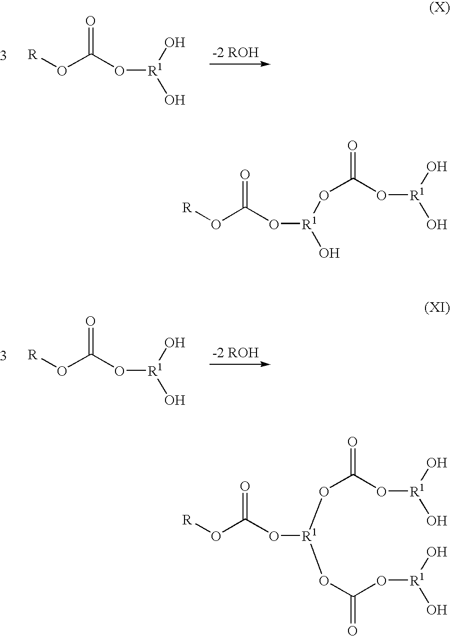

In formula (X) and (XI), R and R¹ are as defined above.

There are various ways of terminating the intermolecular polycondensation reaction. By way of example, the temperature may be lowered to a range where the reaction stops and the product (K) or the polycondensate (P) is storage-stable.

It is also possible to deactivate the catalyst, for example in the case of basic catalysts via addition of Lewis acids or proton acids.

In another embodiment, as soon as the intermolecular reaction of the condensate (K) has produced a polycondensate (P) with the desired degree of polycondensation, a product having groups reactive toward the focal group of (P) may be added to the product (P) to terminate the reaction. In the case of a carbonate group as focal group, by way of example, a mono-, di-, or polyamine may therefore be added. In the case of a hydroxy group as focal group, by way of example, a mono-, di-, or polyisocyanate, or a compound comprising epoxy groups, or an acid derivative which reacts with OH groups, can be added to the product (P).

The highly functional polycarbonates are mostly prepared in a pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the product is stripped, i.e. freed from low-molecular-weight, volatile compounds. For this, once the desired degree of conversion has been reached the catalyst may optionally be deactivated and the low-molecular-weight volatile constituents, e.g. monoalcohols, phenols, carbonates, hydrogen chloride, or volatile oligomeric or cyclic compounds, can be removed by distillation, if appropriate with introduction of a gas, preferably nitrogen, carbon dioxide, or air, if appropriate at reduced pressure.

In another preferred embodiment, the polycarbonates may comprise other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate groups or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulphonic acids, derivatives of phosphonic acids, silane groups, siloxane groups, aryl radicals, or long-chain alkyl radicals, besides hydroxy groups, carbonate groups or carbamoyl groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethylethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups, or urea groups.

Ester groups can be produced via addition of dicarboxylic acids, tricarboxylic acids, or, for example, dimethyl terephthalate, or tricarboxylic esters.

Subsequent functionalization can be achieved by using an additional step of the process to react the resultant highly functional, highly branched, or highly functional hyperbranched polycarbonate with a suitable functionalizing reagent which can react with the OH and/or carbonate groups or carbamoyl groups of the polycarbonate.

By way of example, highly functional highly branched, or highly functional hyperbranched polycarbonates comprising hydroxy groups can be modified via addition of molecules comprising acid groups or isocyanate groups. By way of example, polycarbonates comprising acid groups can be obtained via reaction with compounds comprising anhydride groups.

Highly functional polycarbonates comprising hydroxy groups may moreover also be converted into highly functional polycarbonate polyether polyols via reaction with alkylene oxides, e.g. ethylene oxide, propylene oxide, or butylene oxide.

The flow-improved moulding compositions to be used for the production of the inventive hybrid-based lightweight components can comprise, as component B3), at least one hyperbranched polyester of AₓB_{y} type, where

x is at least 1.1, preferably at least 1.3, in particular at least 2 and
y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B3) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B3) preferably has a molecular weight of from 300 to 30 000 g/mol, in particular from 400 to 25 000 g/mol, and very particularly from 500 to 20 000 g/mol, determined by means of GPC, PMMA standard, dimethylacetamide eluent.

B3) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The Tg (glass transition temperature) is preferably from −50° C. to 140° C., and in particular from −50 to 100° C. (by means of DSC, to DIN 53765).

Preference is particularly given to those components B3) in which at least one OH or COOH number is greater than 0, preferably greater than 0.1, and in particular greater than 0.5.

The component B3) is obtainable via the processes described below, for example by reacting
(m) one or more dicarboxylic acids or one or more derivatives of the same with one or more at least trihydric alcohols
   or
(n) one or more tricarboxylic acids or higher polycarboxylic acids or one or more derivatives of the same with one or more diols in the presence of a solvent and optionally in the presence of an inorganic, organometallic, or low-molecular-weight organic catalyst, or of an enzyme. The reaction in solvent is the preferred preparation method.

Highly functional hyperbranched polyesters B3) have molecular and structural non-uniformity. Their molecular non-uniformity distinguishes them from dendrimers, and they can therefore be prepared at considerably lower cost.

Among the dicarboxylic acids which can be reacted according to variant (m) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid, and the abovementioned dicarboxylic acids may have substitution by one or more radicals selected from C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl; alkylene groups, such as methylene or ethylidene, or C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned as representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (m) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

However, it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (n) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

It is also possible to use a mixture composed of a tri- or polycarboxylic acid and one or more of its derivatives. It is likewise possible to use a mixture of two or more different derivatives of one or more tri- or polycarboxylic acids, in order to obtain component B3).

Examples of diols used for variant (n) are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n=4. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (m) and (n) is from 4:1 to 1:4, in particular from 2:1 to 1:2.

The at least trihydric alcohols reacted according to variant (m) may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (m) may also have hydroxy groups having at least two different chemical reactivities.

The different reactivity of the functional groups here may derive either from chemical causes (e.g. primary/secondary/tertiary OH group) or from steric causes.

By way of example, the triol may comprise a triol which has primary and secondary hydroxy groups, a preferred example being glycerol.

When the reaction is carried out according to variant (m), it is preferable to operate in the absence of diols and of monohydric alcohols.

When the reaction is carried out according to variant (n), it is preferable to operate in the absence of mono- or dicarboxylic acids.

The process is carried out in the presence of a solvent. By way of example, hydrocarbons are suitable, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Other solvents very particularly suitable in the absence of acidic catalysts are: ethers, such as dioxane or tetrahydrofuran, and ketones, such as methyl ethyl ketone and methyl isobutyl ketone.

The amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate decreases markedly at markedly lower concentrations of the reactants, giving uneconomically long reaction times.

To carry out the process, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water trap.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

Examples of acidic inorganic catalysts are sulphuric acid, phosphoric acid, phosphonic acid, hypophosphorous acid, aluminium sulphate hydrate, alum, acidic silica gel (pH=6, in particular=5), and acidic aluminium oxide. Examples of other compounds which can be used as acidic inorganic catalysts are aluminium compounds of the general formula Al(OR)₃ and titanates of the general formula Ti(OR)₄, where each of the radicals R may be identical or different and is selected independently of the others from C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulphonic acid groups, sulphate groups, or phosphonic acid groups. Particular preference is given to sulphonic acids, such as para-toluenesulphonic acid. Acidic ion exchangers may also be used as acidic organic catalysts, e.g. polystyrene resins comprising sulphonic acid groups and crosslinked with about 2 mol % of divinylbenzene.

It is also possible to use combinations of two or more of the abovementioned catalysts. It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The preparation process for component B3) is carried out under an inert gas, for example under carbon dioxide, nitrogen or a noble gas, among which particular mention may be made of argon. The inventive process is carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred. The pressure conditions for the preparation process are not critical. It is possible to operate at markedly reduced pressure, e.g. at from 10 to 500 mbar. The process may also be carried out at pressures above 500 mbar. The reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred. The reaction time is usually from 10 minutes to 25 hours, preferably from 30 minutes to 10 hours, and particularly preferably from one to 8 hours.

Once the reaction has ended, the highly functional hyperbranched polyesters B3) can easily be isolated, e.g. by removing the catalyst by filtration and concentrating the mixture, the concentration process here usually being carried out at reduced pressure. Other work-up methods with good suitability are precipitation after addition of water, followed by washing and drying.

Component B3) can also be prepared in the presence of enzymes or decomposition products of enzymes (according to DE-A 10 163 163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geotrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known, e.g. from Kurt Faber, “Biotransformations in Organic Chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme to be used is from 0.1 to 20% by weight, in particular from 10 to 15% by weight, based on the total weight of the starting materials used and to be reacted.

The process using enzymes is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The process using enzymes is carried out in the presence of a solvent. Examples of suitable compounds are hydrocarbons, such as paraffins or aromatics. Particularly suitable paraffins are 8n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The process using enzymes is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. The reaction at atmospheric pressure is preferred.

The reaction time for the process using enzymes is usually from 4 hours to 6 days, preferably from 5 hours to 5 days, and particularly preferably from 8 hours to 4 days.

Once the reaction has ended, the highly functional hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The highly functional, hyperbranched polyesters B3) obtainable by this enzyme-based process feature particularly low contents of discoloured and resinified material. For the definition of hyperbranched polymers, see also: P. J. Flory, J. Am. Chem. Soc. 1952, 74, 2718, and A. Sunder et al., Chem. Eur. J. 2000, 6, no. 1, 1-8. However, in the context of the present invention, “highly functional hyperbranched” means that the degree of branching, i.e. the average number of dendritic linkages plus the average number of end groups per molecule, is from 10 to 99.9%, preferably from 20 to 99%, particularly preferably from 30 to 90% (see in this connection H. Frey et al. Acta Polym. 1997, 48, 30).

The molar mass M_{w} of the polyesters B3) is from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the polyesters B3) in tetrahydrofuran (THF), n-butyl acetate, ethanol, and numerous other solvents, with no gel particles detectable by the naked eye.

The highly functional hyperbranched polyesters B3) are carboxy-terminated, carboxy- and hydroxy-terminated or hydroxy-terminated, but preferably only hydroxy-terminated.

The hyperbranched polycarbonates B2)/polyesters B3) used are particles whose size is from 20 to 500 nm. These nanoparticles are in finely dispersed form in the polymer blend, the size of the particles in the compounded material being from 20 to 500 nm, preferably from 50 to 300 nm.

Compounded materials of this type are available commercially, e.g. as Ultradur® high speed.

The polyalkylene glycol esters (PAGE) B4) with low molecular weight, of the general formula (XII)

R—COO—(Z—O)ₙOC—R (XII)

in which
R is a branched or straight-chain alkyl group having from 1 to 20 carbon atoms,
Z is a branched or straight-chain C₂ to C₁₅ alkylene group, and
n is a whole number from 2 to 20,
can likewise be used as flow improvers, and are known from WO 98/11164 A1. Particular preference is given to triethylene glycol bis(2-ethylhexanoate) (TEG-EH), marketed as TEG-EH-Plasticizer, CAS No. 94-28-0, by Eastman Chemical B.V., The Hague, Netherlands.

If a mixture of B) components is used, the ratios of the components B1) to B2) or B2) to B3) or B1) to B3) or B1) to B4) or B) to B4) or B3) to B4) are preferably from 1:20 to 20:1, in particular from 1:15 to 15:1 and very particularly from 1:5 to 5:1. If a ternary mixture is used composed of, for example, B1), B2) and B3), the mixing ratio is preferably from 1:1:20 to 1:20:1 or up to 20:1:1. This applies likewise to ternary mixtures using B4).

In one preferred embodiment, the present invention provides lightweight components composed of a main body which is composed of galvanized iron and which has reinforcing structures, where the reinforcing structures have been securely connected to the main body and are composed of moulded-on thermoplastic, characterized in that the thermoplastic used comprises polymer moulding compositions comprising A) from 99.99 to 10 parts by weight, preferably from 99.5 to 40 parts by weight, particularly preferably from 99.0 to 55 parts by weight, of polyamide and

B1) from 0.01 to 50 parts by weight, preferably from 0.25 to 20 parts by weight, particularly preferably from 1.0 to 15 parts by weight, of at least one copolymer composed of at least one olefin, preferably of one α-olefin, with at least one methacrylate or acrylate of an aliphatic alcohol, preferably of an aliphatic alcohol having from 1 to 30 carbon atoms with MFI not less than 100 g/10 min, where the MFI (melt flow index) is measured or determined at 190° C. with a test weight of 2.16 kg and the secure interlock bond between main body and thermoplastic is achieved by way of the galvanized surface of the main body.

In one particularly preferred embodiment, the present invention provides lightweight components obtainable from polymer moulding compositions of components A) and B1) whose main body is of shell-type design, where the exterior or interior of the said body additionally has reinforcing structures securely connected to the main body and composed of the same moulded-on thermoplastic, and, in one alternative embodiment, the connection of these to the main body is additionally achieved at discrete connection sites. These discrete connection sites can preferably be perforations in the main body, where the thermoplastic passes through these perforations and extends over the area of the perforations, thus additionally reinforcing the secure interlock bond which is in any case already being achieved by way of the galvanized iron surface of the main body. The reinforcing structures are preferably of rib shape or of honeycomb shape.

In another preferred embodiment of the present invention, moulding compositions used for the lightweight components of hybrid design also comprise, in addition to components A) and optionally B),
C) from 0.001 to 75 parts by weight, preferably from 10 to 70 parts by weight, particularly preferably from 20 to 65 parts by weight, with particular preference from 30 to 65 parts by weight, of a filler or reinforcing material.

The filler or reinforcing material used can also comprise a mixture composed of two or more different fillers and/or reinforcing materials, for example based on talc, or mica, silicate, quartz, titanium dioxide, wollastonite, kaolin, amorphous silicas, magnesium carbonate, chalk, feldspar, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspar, barium sulphate and/or glass fibres. It is particularly preferable to use mineral particulate fillers based on talc, wollastonite, kaolin and/or glass fibres, very particular preference being given to glass fibres.

Particularly for applications in which isotropy in dimensional stability and high thermal dimensional stability is demanded, as for example in motor vehicle applications for external bodywork parts, it is preferable to use mineral fillers, in particular talc, wollastonite or kaolin.

Particular preference is moreover also given to the use of acicular mineral fillers. According to the invention, the term acicular mineral fillers means a mineral filler having pronounced acicular character. An example that may be mentioned is acicular wollastonites. The length:diameter ratio of the mineral is preferably from 2:1 to 35:1, particularly preferably from 3:1 to 19:1, with particular preference from 4:1 to 12:1. The average particle size, determined using a CILAS GRANULOMETER, of the inventive acicular minerals is preferably smaller than 20 μm, particularly preferably smaller than 15 μm, with particular preference smaller than 10 μm.

The filler and/or reinforcing material can, if appropriate, have been surface-modified, for example with a coupling agent or coupling-agent system, for example based on silane. However, this pre-treatment is not essential. However, in particular when glass fibres are used it is also possible to use polymer dispersions, film-formers, branching agents and/or glass-fibre-processing aids, in addition to silanes.

The glass fibres whose use is particularly preferred according to the invention are added in the form of continuous-filament fibres or in the form of chopped or ground glass fibres, their fibre diameter generally being from 7 to 18 μm, preferably from 9 to 15 μm. The fibres can have been provided with a suitable size system and with a coupling agent or coupling-agent system, for example based on silane.

Coupling agents based on silane and commonly used for the pretreatment process are silane compounds, preferably silane compounds of the general formula (XIII)

(M-(CH₂)_{q})ₖ—Si—(O—CᵣH₂ᵣ₊₁)₄₋ₖ (XIII)

in which

### M is NH₂—, HO— or

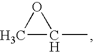

q is a whole number from 2 to 10, preferably from 3 to 4,
r is a whole number from 1 to 5, preferably from 1 to 2 and
k is a whole number from 1 to 3, preferably 1.

Coupling agents to which further preference is given are silane compounds from the group of aminopropyltrimethoxysilane, aminobutyltrimethoxysilane, aminopropyltriethoxysilane, aminobutyltriethoxysilane, and also the corresponding silanes which have a glycidyl group as substituent X.

The amounts generally used of the silane compounds for surface coating for modification of the fillers is from 0.05 to 2% by weight, preferably from 0.25 to 1.5% by weight and in particular from 0.5 to 1% by weight, based on the mineral filler.

As a result of the processing to give the moulding composition or moulding, the d97 value or d50 value of the particulate fillers can be smaller in the moulding composition or in the moulding than in the fillers originally used. As a result of the processing to give the moulding composition or moulding, the length distributions of the glass fibres in the moulding composition or the moulding can be shorter than those originally used.

In an alternative preferred embodiment, the polymer moulding compositions to be used for the production of the lightweight components of hybrid design according to the invention can also, if appropriate, comprise, in addition to components A) and, if appropriate, B) and/or C), or instead of B) and/or C),
D) from 0.001 to 30 parts by weight, preferably from 5 to 25 parts by weight, particularly preferably from 9 to 19 parts by weight, of at least one flame-retardant additive.

The flame-retardant additive or flame retardant D) used can comprise commercially available organic halogen compounds with synergists or can comprise commercially available organic nitrogen compounds or organic/inorganic phosphorus compounds, individually or in a mixture. It is also possible to use mineral flame-retardant additives such as magnesium hydroxide or Ca Mg carbonate hydrates (e.g. DE-A 4 236 122 (=CA 210 9024 A1)). It is also possible to use salts of aliphatic or aromatic sulphonic acids. Examples that may be mentioned of halogen-containing, in particular brominated and chlorinated, compounds are: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate, brominated polystyrene and decabromodiphenyl ether. Examples of suitable organic phosphorus compounds are the phosphorus compounds according to WO-A 98/17720 (=U.S. Pat. No. 6,538,024), e.g. triphenyl phosphate (TPP), resorcinol bis(diphenyl phosphate) (RDP) and the oligomers derived therefrom, and also bisphenol A bis(diphenyl phosphate) (BDP) and the oligomers derived therefrom, and moreover organic and inorganic phosphonic acid derivatives and their salts, organic and inorganic phosphinic acid derivatives and their salts, in particular metal dialkylphosphinates, such as aluminium tris[dialkylphosphinates] or zinc bis[dialkylphosphinates], and moreover red phosphorus, phosphites, hypophosphites, phosphine oxides, phosphazenes, melamine pyrophosphate and mixtures of these. Nitrogen compounds that can be used are those from the group of the allantoin derivatives, cyanuric acid derivatives, dicyandiamide derivatives, glycoluril derivatives, guanidine derivatives, ammonium derivatives and melamine derivatives, preferably allantoin, benzoguanamine, glycoluril, melamine, condensates of melamine, e.g. melem, melam or melom, or compounds of this type having higher condensation level and adducts of melamine with acids, e.g. with cyanuric acid (melamine cyanurate), with phosphoric acid (melamine phosphate) or with condensed phosphoric acids (e.g. melamine polyphosphate). Examples of suitable synergists are antimony compounds, in particular antimony trioxide, sodium antimonate and antimony pentoxide, zinc compounds, e.g. zinc borate, zinc oxide, zinc phosphate and zinc sulphide, tin compounds, e.g. tin stannate and tin borate, and also magnesium compounds, e.g. magnesium oxide, magnesium carbonate and magnesium borate. Materials known as carbonizers can also be added to the flame retardant, examples being phenol-formaldehyde resins, polycarbonates, polyphenyl ethers, polyimides, polysulphones, polyether sulphones, polyphenylene sulphides, and polyether ketones, and also antidrip agents, such as tetrafluoroethylene polymers.

In another alternative preferred embodiment, the polymer moulding compositions to be used for the production of the lightweight components of hybrid design according to the invention can also, if appropriate, comprise, in addition to components A) and, if appropriate, B) and C) and/or D), or instead of B) and/or C) and/or D),
E) from 0.001 to 80 parts by weight, particularly preferably from 2 to 19 parts by weight, with particular preference from 9 to 15 parts by weight, of at least one elastomer modifier.

The elastomer modifiers to be used as component E) comprise one or more graft polymers of
E.1 from 5 to 95% by weight, preferably from 30 to 90% by weight, of at least one vinyl monomer on
E.2 from 95 to 5% by weight, preferably from 70 to 10% by weight, of one or more graft bases whose glass transition temperatures are <10° C., preferably <0° C., particularly preferably <−20° C.

The average particle size (d₅₀ value) of the graft base E.2 is generally from 0.05 to 10 μm, preferably from 0.1 to 5 μm, particularly preferably from 0.2 to 1 μm.

Monomers E.1 are preferably mixtures composed of
E.1.1 from 50 to 99% by weight of vinylaromatics and/or ring-substituted vinylaromatics (such as styrene, α-methylstyrene, p-methylstyrene, p-chlorostyrene) and/or (C₁-C₈)-alkyl methacrylates (e.g. methyl methacrylate, ethyl methacrylate) and
E.1.2 from 1 to 50% by weight of vinyl cyanides (unsaturated nitriles, such as acrylonitrile and methacrylonitrile) and/or (C₁-C₈)-alkyl (meth)acrylates (e.g. methyl methacrylate, n-butyl acrylate, tert-butyl acrylate) and/or derivatives (such as anhydrides and imides) of unsaturated carboxylic acids (e.g. maleic anhydride and N-phenylmaleimide).

Preferred monomers E.1.1 have been selected from at least one of the monomers styrene, α-methylstyrene and methyl methacrylate, and preferred monomers E.1.2 have been selected from at least one of the monomers acrylonitrile, maleic anhydride and methyl methacrylate.

Particularly preferred monomers are E.1.1 styrene and E.1.2 acrylonitrile.

Examples of suitable graft bases E.2 for the graft polymers to be used in the elastomer modifiers E) are diene rubbers, EP(D)M rubbers, i.e. rubbers based on ethylene/propylene and, if appropriate, diene, acrylate rubbers, polyurethane rubbers, silicone rubbers, chloroprene rubbers and ethylene-vinyl acetate rubbers.

Preferred graft bases E.2 are diene rubbers (e.g. based on butadiene, isoprene, etc.) or mixtures of diene rubbers, or are copolymers of diene rubbers or of their mixtures with further copolymerizable monomers (e.g. according to E.1.1 and E.1.2), with the proviso that the glass transition temperature of component E.2 is <10° C., preferably <0° C., particularly preferably <−10° C.

Examples of particularly preferred graft bases E.2 are ABS polymers (emulsion, bulk and suspension ABS), as described by way of example in DE-A 2 035 390 (=U.S. Pat. No. 3,644,574) or in DE-A 2 248 242 (=GB-A 1 409 275) or in Ullmann, Enzyklopädie der Technischen Chemie [Encyclopaedia of Industrial Chemistry], Vol. 19 (1980), pp. 280 et seq. The gel content of the graft base E.2 is preferably at least 30% by weight, particularly preferably at least 40% by weight (measured in toluene).

The elastomer modifiers or graft polymers E) are prepared via free-radical polymerization, e.g. via emulsion, suspension, solution or bulk polymerization, preferably via emulsion or bulk polymerization.

Other particularly suitable graft rubbers are ABS polymers which are prepared via redox initiation using an initiator system composed of organic hydroperoxide and ascorbic acid according to U.S. Pat. No. 4,937,285.

Because it is known that the graft monomers are not necessarily entirely grafted onto the graft base during the grafting reaction, products which are obtained via (co)polymerization of the graft monomers in the presence of the graft base and are produced concomitantly during the work-up are also graft polymers E) according to the invention.

Suitable acrylate rubbers are based on graft bases E.2 which are preferably polymers composed of alkyl acrylates, if appropriate with up to 40% by weight, based on E.2, of other polymerizable, ethylenically unsaturated monomers. Among the preferred polymerizable acrylic esters are C₁-C₈-alkyl esters, such as methyl, ethyl, butyl, n-octyl and 2-ethylhexyl esters; haloalkyl esters, preferably halo-C₁-C₈-alkyl esters, such as chloroethyl acrylate, and also mixtures of these monomers.

For crosslinking, monomers having more than one polymerizable double bond can be copolymerized. Preferred examples of crosslinking monomers are esters of unsaturated monocarboxylic acids having from 3 to 8 carbon atoms and esters of unsaturated monohydric alcohols having from 3 to 12 carbon atoms, or of saturated polyols having from 2 to 40H groups and from 2 to 20 carbon atoms, e.g. ethylene glycol dimethacrylate, allyl methacrylate; polyunsaturated heterocyclic compounds, e.g. trivinyl and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which have at least three ethylenically unsaturated groups.

Particularly preferred crosslinking monomers are the cyclic monomers triallyl cyanurate, triallyl isocyanurate, triacryloylhexahydro-s-triazine, and triallylbenzenes. The amount of the crosslinked monomers is preferably from 0.02 to 5% by weight, in particular from 0.05 to 2% by weight, based on the graft base E.2.

In the case of cyclic crosslinking monomers having at least three ethylenically unsaturated groups, it is advantageous to restrict the amount to below 1% by weight of the graft base E.2.

Examples of preferred “other” polymerizable, ethylenically unsaturated monomers which can serve alongside the acrylic esters, if appropriate, for preparation of the graft base E.2 are acrylonitrile, styrene, α-methylstyrene, acrylamides, vinyl C₁-C₆-alkyl ethers, methyl methacrylate, butadiene. Acrylate rubbers preferred as graft base E.2 are emulsion polymers whose gel content is at least 60% by weight.

Further suitable graft bases according to E.2 are silicone rubbers having sites active for grafting purposes, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Alongside elastomer modifiers based on graft polymers, it is also possible to use, as component E), elastomer modifiers not based on graft polymers but having glass transition temperatures <10° C., preferably <0° C., particularly preferably <−20° C. Among these can be, by way of example, elastomers with block copolymer structure. Among these can also be, by way of example, elastomers which can undergo thermoplastic melting. Preferred materials mentioned here by way of example are EPM rubbers, EPDM rubbers and/or SEBS rubbers.

In another alternative preferred embodiment, the polymer moulding compositions to be used for the production of the lightweight components of hybrid design according to the invention can also, if appropriate, comprise, in addition to components A) and, if appropriate, B) and/or C) and/or D) and/or E), or instead of B), C), D) or E),
F) from 0.001 to 10 parts by weight, preferably from 0.05 to 3 parts by weight, particularly preferably from 0.1 to 0.9 part by weight, of further conventional additives.

For the purposes of the present invention, examples of conventional additives are stabilizers (e.g. UV stabilizers, heat stabilizers, gamma-ray stabilizers), antistatic agents, flow aids, mould-release agents, further fire-protection additives, emulsifiers, nucleating agents, plasticizers, lubricants, dyes, pigments and additives for increasing electrical conductivity. The additives mentioned and further suitable additives are described by way of example in Gächter, Müller, Kunststoff-Additive [Plastics Additives], 3rd Edition, Hanser-Verlag, Munich, Vienna, 1989 and in Plastics Additives Handbook, 5th Edition, Hanser-Verlag, Munich, 2001. The additives may be used alone or in a mixture, or in the form of masterbatches.

Preferred stabilizers used are sterically hindered phenols, hydroquinones, aromatic secondary amines, e.g. diphenylamines, substituted resorcinols, salicylates, benzotriazoles and benzophenones, and also various substituted representatives of these groups and mixtures thereof.

Preferred pigments and dyes used are titanium dioxide, zinc sulphide, ultramarine blue, iron oxide, carbon black, phthalocyanines, quinacridones, perylenes, nigrosin and anthraquinones.

Preferred nucleating agents used are sodium phenylphosphinate or calcium phenylphosphinate, aluminium oxide, silicon dioxide, or else talc, particularly preferably talc.

Preferred lubricants and mould-release agents used are ester waxes, pentaerythritol tetrastearate (PETS), long-chain fatty acids (e.g. stearic acid or behenic acid) and fatty acid esters, salts thereof (e.g. Ca stearate or Zn stearate), and also amide derivatives (e.g. ethylenebisstearylamide) or montan waxes (mixtures composed of straight-chain, saturated carboxylic acids having chain lengths of from 28 to 32 carbon atoms), and also low-molecular-weight polyethylene waxes and polypropylene waxes.

Preferred plasticizers used are dioctyl phthalate, dibenzyl phthalate, butyl benzyl phthalate, hydrocarbon oils, N-(n-butyl)benzenesulphonamide.

Preferred additives which can be added to increase electrical conductivity are carbon blacks, conductivity blacks, carbon fibrils, nanoscale graphite fibres and carbon fibres, graphite, conductive polymers, metal fibres, and also other conventional additives for increasing electrical conductivity. Nanoscale fibres which can preferably be used are those known as “single-wall carbon nanotubes” or “multiwall carbon nanotubes” (e.g. from Hyperion Catalysis).

In another alternative preferred embodiment, the polyamide moulding compositions can also, if appropriate, comprise, in addition to components A) and, if appropriate, B) and/or C), and/or D), and/or E), and/or F), or instead of B), C), D), E) or F),
G) from 0.5 to 30 parts by weight, preferably from 1 to 20 parts by weight, particularly preferably from 2 to 10 parts by weight and most preferably from 3 to 7 parts by weight, of compatibilizer.

Compatibilizers used preferably comprise thermoplastic polymers having polar groups.

According to the invention, polymers which can be used are therefore those which contain
G.1 a vinylaromatic monomer,
G.2 at least one monomer selected from the group of C₂-C₁₂-alkyl methacrylates, C₂-C₁₂-alkyl acrylates, methacrylonitriles and acrylonitriles and
G.3 dicarboxylic anhydrides containing α,β-unsaturated components.

The component used composed of G.1, G.2 and G.3 preferably comprises terpolymers of the monomers mentioned. Accordingly, it is preferable to use terpolymers of styrene, acrylonitrile and maleic anhydride. In particular, these terpolymers contribute to improvement in mechanical properties, such as tensile strength and tensile strain at break. The amount of maleic anhydride in the terpolymer can vary widely. The amount is preferably from 0.2 to 5 mol %. Amounts of from 0.5 to 1.5 mol % are particularly preferred. In this range, particularly good mechanical properties are achieved in relation to tensile strength and tensile strain at break.

The terpolymer can be prepared in a known manner. One suitable method is to dissolve monomer components of the terpolymer, e.g. styrene, maleic anhydride or acrylonitrile, in a suitable solvent, e.g. methyl ethyl ketone (MEK). One or, if appropriate, more chemical initiators are added to this solution. Preferred initiators are peroxides. The mixture is then polymerized at elevated temperatures for a number of hours. The solvent and the unreacted monomers are then removed in a manner known per se.

The ratio of component G.1 (vinylaromatic monomer) to component G.2, e.g. the acrylonitrile monomer in the terpolymer is preferably from 80:20 to 50:50.

Styrene is particularly preferred as vinylaromatic monomer G.1. Acrylonitrile is particularly preferably suitable for component G.2. Maleic anhydride is particularly preferably suitable as component G.3.

EP-A 0 785 234 (=U.S. Pat. No. 5,756,576) and EP-A 0 202 214 (=U.S. Pat. No. 4,713,415) describe examples of compatibilizers G) which can be used according to the invention. According to the invention, particular preference is given to the polymers mentioned in EP-A 0 785 234.

The compatibilizers can be present in component G) alone or in any desired mixture with one another.

Another substance particularly preferred as compatibilizer is a terpolymer of styrene and acyrlonitrile in a ratio of 2.1:1 by weight containing 1 mol % of maleic anhydride.

Component G) is used particularly when the moulding composition comprises graft polymers, as described under E).

According to the invention, the following combinations of the components are preferred in polymer moulding compositions for use in hybrid-based lightweight components:

A; A,B; A,B,C; A,B,D; A,B,E; A,B,F; A,B,G; A,B,C,D; A,B,C,E; A,B,C,F; A,B,C,G; A,B,D,E; A,B,D,F; A,B,D,G; A,B,E,F; A,B,E,G; A,B,F,G; A,B,C,D,E; A,B,C,D,G; A,B,C,F,G; A,B,E,F,G; A,B,D,F,G; A,B,C,D,E,F; A,B,C,D,E,G; A,B,D,E,F,G; A,B,C,E,F,G; A,B,C,D,E,G; A,B,C,D,E,F,G.

The bodywork side frames produced according to the invention with sandwich structure from the polymer moulding compositions used, and based on the application of plastics-metal-hybrid technology across the entire component, feature an exceptionally secure connection of the main body, i.e. of the side frame composed of outer frame component and inner frame component, to the thermoplastic.

The reinforcement structures produced according to the invention from polyamide which is to be used with particular preference and to which flow improver has been admixed have very high impact resistance, and also have an unusually high modulus of elasticity of about 19 000 MPa at room temperature. In the event that polyamide is used in combination, for example, with a component B1), the content of glass fibres can be doubled from 30% by weight to 60% by weight, giving double the stiffness of a bodywork side frame produced therefrom. Surprisingly, the density of the polymer moulding composition increases by only about 15-20% here. This permits a significant reduction in the wall thicknesses of the components, i.e. of the metal outer frame and of the metal inner frame, for the same mechanical performance, with markedly reduced manufacturing costs. Surprisingly, reductions of from 30 to 40% in weight and in manufacturing costs can be achieved by the component according to the invention for a bodywork side frame, when comparison is made with a component manufactured conventionally.

However, the present invention also provides a process for the production of a bodywork frame side component of motor vehicles, preferably cars, characterized in that respectively a metal outer frame manufactured as a single piece and a metal inner frame manufactured from a minimum small number of individual metal sheets, and particularly preferably manufactured as a single part, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames, and the shaping of the two frame constituents, i.e. of the metal outer frame and of the metal inner frame, takes place in advance via shaping processes in respectively a shaping mould.

However, the present invention also provides a method for reduction of the weight of motor vehicles, preferably of cars, characterized in that the bodywork is composed of a frame side component which respectively has a metal outer frame manufactured as a single piece and a metal inner frame manufactured from a minimum small number of individual metal sheets, particularly preferably manufactured as a single part, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.

However, the present invention also provides motor vehicles, preferably cars, characterized in that their bodywork is composed of a frame side component which respectively has a metal outer frame manufactured as a single piece and a metal inner frame manufactured from a minimum small number of individual metal sheets, and particularly preferably manufactured as a single part, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.

It will be understood that the specification and examples are illustrative but not limitative of the present invention and that other embodiments within the spirit and scope of the invention will suggest themselves to those skilled in the art.

### Examples

Bodywork frame side components which have been produced according to the invention and which were based on a metal outer frame and on a metal inner frame composed of galvanized sheet iron were produced with the following plastics according to pages 7-39 of the description in the brochure Durethan®: technische Kunststoffe auf Basis von Polyamid 6, Polyamid 66 and Copolyamid [Engineering plastics based on nylon-6, nylon-6,6 and copolyamide] from Lanxess Deutschland GmbH, Leverkusen, Germany, order No.: LXS-SCP-012 DE, 2008-07 issue:

a) Durethan® BKV30H2.0 (glass-fibre-reinforced base-grade PA 6)
b) Durethan® DP BKV60H2.0 EF (glass-fibre-reinforced, free-flowing-grade PA 6)
c) Durethan® DP BKV35 XF (glass-fibre-reinforced, extremely free-flowing-grade PA 6)
d) Durethan® BKV215 (glass-fibre-reinforced improved-toughness-grade PA 6)
e) Durethan® B30S (unreinforced base-grade PA 6)
f) Durethan® AKV50H2.0 (glass-fibre-reinforced base-grade PA 6,6)

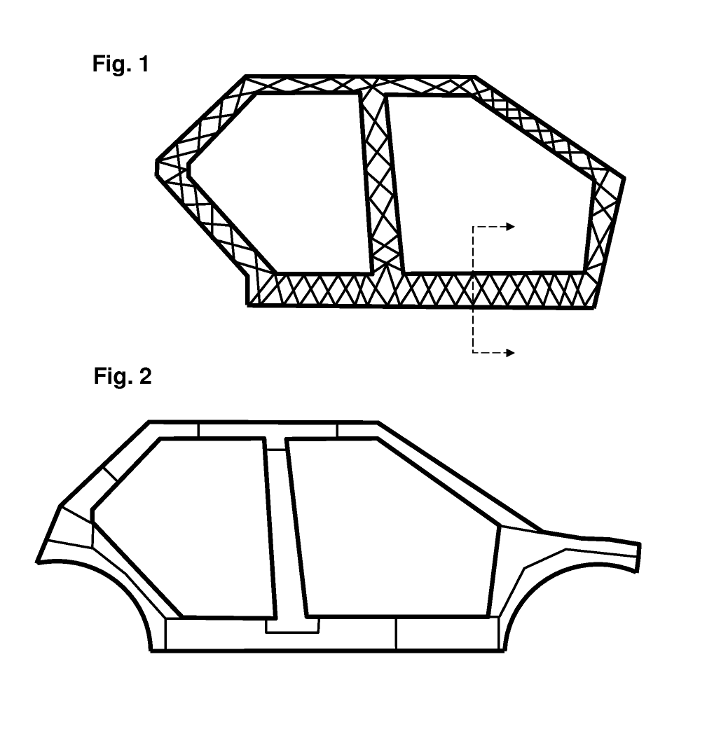

FIG. 1: Plan view of outer hybrid side wall from “inside”, A=outer hybrid side wall

FIG. 2: Plan view of inner side wall (as assembly) from “inside”, B=inner side wall

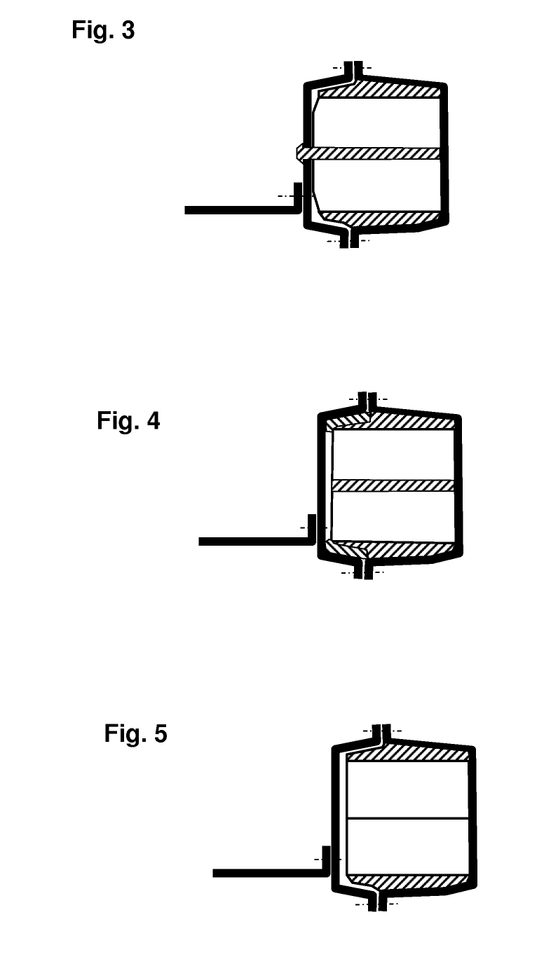

FIG. 3: Section through the side wall (as assembly) in the door-sill region (see broken line in FIG. 1); connection of the plastics structure to the inner side wall at plastics pegs (as constituent of the plastics structure) which protrude through apertures in the metal sheet and are subsequently flattened by heating (e.g. by the hot-riveting process)

FIG. 4: Section through the side wall (as assembly) in the door-sill region (see broken line in FIG. 1); connection of the plastics structure to the inner side wall via foamable plastics component or via an adhesive, which was either previously used during the welding of the sheet-metal shells—or is applied subsequently (after the welding of the metal sheets of the side wall)

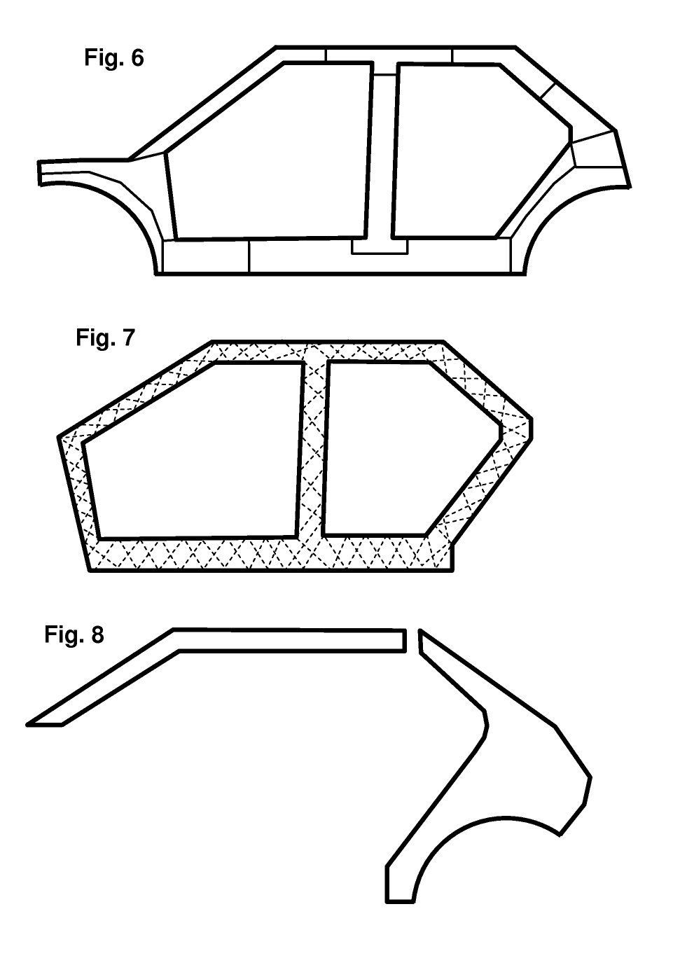

FIG. 5: Section through the side wall (as assembly) in the door-sill region (see broken line in FIG. 1)—without direct linkage of the plastic structure to the inner side wall

FIG. 6: Plan view of inner side wall (assembly) from outside

FIG. 7: Plan view of outer hybrid side wall from outside (obscured ribs shown using broken lines)

FIG. 8: Bodywork panels

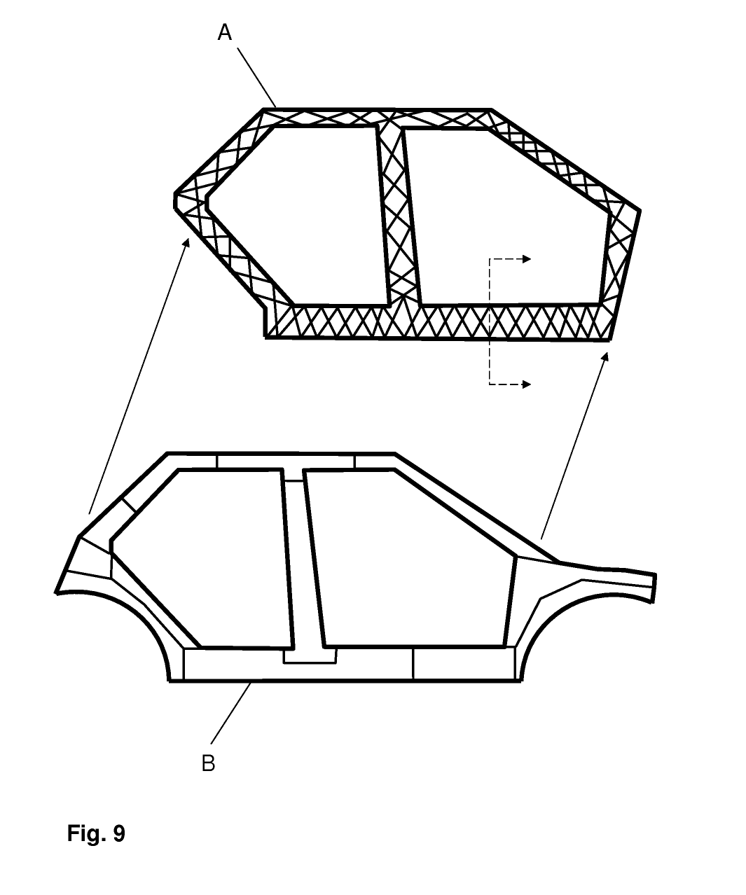

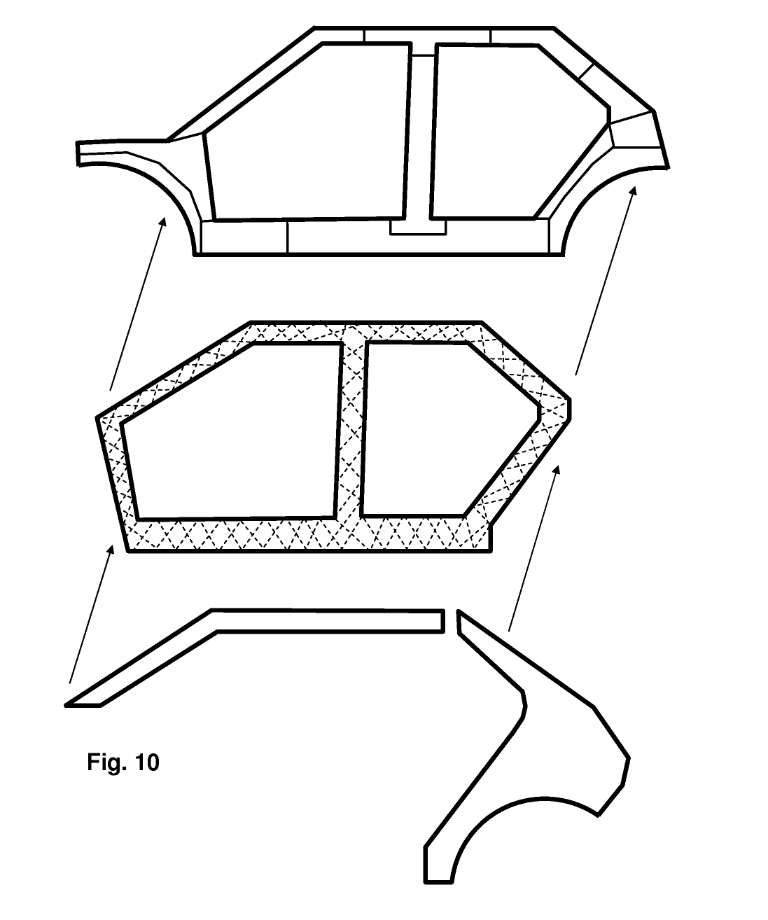

FIG. 9 shows the manner in which the components of FIG. 1 and FIG. 2 are combined

FIG. 10 shows the manner in which the components of FIG. 6, FIG. 7 and FIG. 8 are combined

What is claimed is:

1. A frame side component of bodywork of motor vehicles wherein a metal outer frame manufactured as a single piece and a metal inner frame manufactured from a minimum small number of individual metal sheets where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.

2. A frame side component according to claim 1, wherein the metal inner frame is manufactured as a single part.

3. A frame side component according to claim 1, wherein the vehicle is a car.

4. A frame side component according to claim 1, wherein the plastic is selected from the group of polyesters, polyamides, polyurethanes, polycarbonates or polyalkylenes.

5. A frame side component according to claim 4, wherein the plastic is a combination of component A) nylon-6 (PA 6) or nylon-6,6 (PA 66) with relative solution viscosities (measured in m-cresol at 25° C.) of from 2.0 to 4.0 or a mixture composed of from 99.99 to 10 parts by weight of polyamide with at least
B) from 0.01 to 50 parts by weight of an additional flow improver from the group
B1) of a copolymer composed of at least one olefin with at least one methacrylate or acrylate of an aliphatic alcohol whose MFI (melt flow index) is not less than 100 g/10 min, where the MFI is measured or determined at 190° C. with a load of 2.16 kg, or
B2) of a highly branched or hyperbranched polycarbonate with an OH number of from 1 to 600 mg KOH/g of polycarbonate (to DIN 53240, Part 2), or
B3) of a highly branched or hyperbranched polyester of AₓB_{y} type, where x is at least 1.1 and y is at least 2.1 or
B4) of a polyalkylene glycol ester (PAGE) with low molecular weight of the general formula (I)
R—COO—(Z—O)ₙOC—R (I)
in which
R is a branched or straight-chain alkyl group having from 1 to 20 carbon atoms,
Z is a branched or straight-chain C₂ to C₁₅ alkylene group and
n is a whole number from 2 to 20, or
a mixture of B1) with B2) or of B2) with B3) or of B1) with B3) or of B1) with B2) and with B3) or of B1) with B4) or of B2) with B4) or of B3) with B4), or a ternary mixture of components B1) to B4).

6. A frame side component according to claim 5, wherein the polyamides have linear macromolecular chains and macromolecular chains with a star-shaped structure.

7. A frame side component according to claim 6, wherein the use of these polyamides is irrespective of the use of a component B).

8. A frame side component according to claim 1, wherein the secure interlock bond between the reinforcement structures to be produced from moulded-on plastic and the metal outer frame and the metal inner frame is additionally effected by way of discrete connection sites by way of perforations in the metal outer frame and in the metal inner frame, where the thermoplastic extends through these and over the surface of the perforations.

9. A frame side component according to claim 1, wherein C) from 0.001 to 75 parts by weight of a filler or reinforcing material, in addition to components A) and, if appropriate, B) is used during the production of the moulding compositions.

10. A frame side component according to claim 9, wherein the filler or reinforcing material comprises glass fibres.

11. A frame side component according to claim 1, wherein the reinforcement structures have the shape of ribs, which together can form rectangular, diamond-shaped or honeycomb structures.

12. A frame side component according to claim 1, wherein the fastening points of the plastic which are visible on the metal outer frame, on the outer side, are covered by plastics coverings.

13. A frame side component according to claim 1, wherein the region of the roof arch and also the metal outer frame and also of the metal inner frame is a rounded region.

14. A frame side component according to claim 1, wherein the cross section of the region intended to form the central column (B-column) changes along its length.

15. A frame side component according to claim 14, wherein the cross section increases from the region connected to the roof arch to the region connected to the longitudinal member.

16. A frame side component according to claim 1, wherein the metal outer frame preferably has a U-shaped cross section in the region which is intended to form the B-column and the longitudinal member.

17. A frame side component according to claim 1, wherein the metal outer frame and metal inner frame are secured or connected to one another via weld points.

18. A frame side component according to claim 1, wherein both the metal outer frame and the metal inner frame are obtained via hydroforming and have variable cross sections which vary as a function of the stiffness of the respective bodywork region to be achieved in certain zones.

19. A frame side component according to claim 1, wherein the metal outer frame and the metal inner frame have, in the region of the body-floor longitudinal member to be formed, along their length, a thickness which varies as a function of the stiffness to be achieved in certain zones.

20. A process for the production of a bodywork frame side component of motor vehicles, wherein a metal outer frame manufactured as a single piece and a metal inner frame manufactured from a minimum small number of individual metal sheets, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames, and the shaping of the two frame constituents, i.e. of the metal outer frame and of the metal inner frame, takes place in advance via shaping processes in respectively a shaping mould.

21. A method for reduction of the weight of motor vehicles, wherein the bodywork is composed of a frame side component which respectively has a metal outer frame manufactured as a single piece and a metal inner frame manufactured as a single piece, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.

22. A Motor vehicle, wherein their bodywork is composed of a frame side component which respectively has a metal outer frame manufactured as a single piece and a metal inner frame manufactured from a minimum small number of individual metal sheets, where these respectively have at least one aperture delimited by a roof arch segment, a body-floor longitudinal-member segment and a central-column segment, and are securely connected to one another, and the cavities produced between metal outer frame and metal inner frame via the connection are reinforced by reinforcement structures composed of moulded-on plastic, where the reinforcement structures enter into a secure metal-plastic connection with the two frames.
